(19) United States
(12) Patent Application Publication
(10) Pub. No.: US 2016/0075894 A1
(43) Pub. Date: Mar. 17, 2016

(54) ACTIVE ENERGY RAY-CURABLE COMPOSITION, ACTIVE ENERGY RAY-CURABLE INK, COMPOSITION STORING CONTAINER, IMAGE FORMING APPARATUS, IMAGE FORMING METHOD, CURED PRODUCT, AND SHAPED PRODUCT

(71) Applicants: Soh NOGUCHI, Kanagawa (JP); Mitsunobu Morita, Shizuoka (JP); Daisuke Miki, Kanagawa (JP)

(72) Inventors: Soh NOGUCHI, Kanagawa (JP); Mitsunobu Morita, Shizuoka (JP); Daisuke Miki, Kanagawa (JP)

(21) Appl. No.: 14/851,302

(22) Filed: Sep. 11, 2015

(30) Foreign Application Priority Data
Sep. 17, 2014 (JP) 2014-188624
Jun. 3, 2015 (JP) 2015-113058

(51) Int. Cl. C09D 11/30; C09D 11/107

(52) U.S. Cl. CPC C09D 11/30; C09D 11/107

(57) ABSTRACT

Provided is an active energy ray-curable composition, including: reactive compounds including two or more kinds of multifunctional monomers, wherein one of the two or more kinds of multifunctional monomers is glycerin tri(meth)acrylate, and a content of the multifunctional monomers is 90% by mass or greater relative to a total mass of the reactive compounds.

### BACKGROUND OF THE INVENTION

1. Field of the Invention

The present invention relates to: an active energy ray-curable composition suitable as an inkjet ink; an active energy ray-curable ink; a composition storing container storing the composition; and an image forming apparatus, an image forming method, a cured product, and a shaped product each using the composition.

2. Description of the Related Art

As an inkjet ink, there is known an active energy ray-curable inkjet ink that is cured with active energy rays and fixed. Typically, an inkjet ink is required to have such a low viscosity that enables the ink to be jetted. However, when multifunctional monomers are used in an ink in a large amount in order to increase curability of the ink and hardness of a cured product, the viscosity of the ink will be high, making it difficult for the ink to be jetted from an inkjet head in some cases. When a composition mainly composed of multifunctional monomers is cured, the resulting cured product tends to have a poor close adhesiveness with a base material such as a recording medium and a plastic film.

For example, Japanese Patent Application Laid-Open (JP-A) No. 2006-265276 discloses an invention relating to an ultraviolet ray-curable composition for an optical disk that contains a compound having three or more (meth)acryloyl groups. JP-A No. 2013-136737 discloses an invention relating to an active energy ray-curable hard coat composition that contains monofunctional (meth)acrylate having a vinyl ether group or an allyl ether group or both and free of a hydroxyl group, trifunctional or higher (meth)acrylate free of a hydroxyl group, and a polymerization initiator. JP-A No. 2014-084339 discloses an invention relating to a photocurable inkjet ink that contains a specific organic solvent (A), and a (meth)acrylate compound (B) having a fluorene skeleton in a molecule thereof, and discloses that the photocurable inkjet ink may further contain glycerin tri(meth)acrylate as a radical polymerizable group-containing compound (F) in claim 8.

### SUMMARY OF THE INVENTION

The compositions and the ink according to these inventions, however, cannot be said to be satisfactory considering the levels recently required in terms of curability, hardness of a cured product, and close adhesiveness with a base material.

Hence, an object of the present invention is to provide an active energy ray-curable composition that has a sufficiently low viscosity and a high close adhesiveness even though it contains multifunctional monomers in a large amount, and that is particularly suitable as an inkjet ink.

As a result of extensive studies, the present inventors have found that the problems described above can be solved with the use of specific multifunctional monomers, and completed the present invention. That is, the problems described above can be solved by invention 1) below.

1) An active energy ray-curable composition, including:

reactive compounds including two or more kinds of multifunctional monomers,

wherein one of the two or more kinds of multifunctional monomers is glycerin tri(meth)acrylate, and

wherein a content of the multifunctional monomers is 90% by mass or greater relative to a total mass of the reactive compounds.

The present invention can provide an active energy ray-curable composition that has a sufficiently low viscosity and a high close adhesiveness even though it contains multifunctional monomers in a large amount, and that is particularly suitable as an inkjet ink.

### BRIEF DESCRIPTION OF THE DRAWINGS

FIG. 1 is a schematic view of an example of an image forming apparatus of the present invention.

FIG. 2 is a schematic view of an example of another image forming apparatus of the present invention.

FIG. 3A is a schematic view of an example of still another image forming apparatus of the present invention.

FIG. 3B is a schematic view of an example of still another image forming apparatus of the present invention.

FIG. 3C is a schematic view of an example of still another image forming apparatus of the present invention.

FIG. 3D is a schematic view of an example of still another image forming apparatus of the present invention.

### DETAILED DESCRIPTION OF THE INVENTION

The above invention 1) will be described in detail below. An embodiment of the invention 1) includes 2) to 14) below. Hence, 2) to 14) will also be described below.

2) The active energy ray-curable composition according to 1),

wherein a content of the glycerin tri(meth)acrylate is 50% by mass or greater relative to the total mass of the reactive compounds.

3) The active energy ray-curable composition according to 1) or 2),

wherein the active energy ray-curable composition is free of an organic solvent.

4) The active energy ray-curable composition according to any one of 1) to 3),

wherein the reactive compounds consist of bifunctional or higher monomers.

5) The active energy ray-curable composition according to any one of 1) to 3),

wherein the reactive compounds consist of trifunctional or higher monomers.

6) The active energy ray-curable composition according to any one of 1) to 5),

wherein the active energy ray-curable composition is free of an organic solvent, and has a viscosity of from 3 mPa·s to 40 mPa·s at 25° C.

7) The active energy ray-curable composition according to any one of 1) to 6),

wherein the active energy ray-curable composition is a three-dimensional object forming material.

8) An active energy ray-curable ink, including:

reactive compounds including two or more kinds of multifunctional monomers,

wherein one of the two or more kinds of multifunctional monomers is glycerin tri(meth)acrylate, and

wherein a content of the multifunctional monomers is 90% by mass or greater relative to a total mass of the reactive compounds. 9) The active energy ray-curable ink according to 8),

wherein the active energy ray-curable ink is used for ink jetting. 10) A composition storing container, including:

the active energy ray-curable composition according to any one of 1) to 6).

11) A two-dimensional or three-dimensional image forming apparatus, including:

a storing section storing the active energy ray-curable composition according to any one of 1) to 6); and

an irradiating unit configured to emit active energy rays.

12) A two-dimensional or three-dimensional image forming method, including:

irradiating the active energy ray-curable composition according to any one of 1) to 6) with active energy rays.

13) A cured product obtained by curing the active energy ray-curable composition according to any one of 1) to 6).

14) A shaped product obtained by processing a structure, the structure including a base material and the cured product according to 13) formed over the base material.

### <Active Energy Rays>

Active energy rays used for curing an active energy ray-curable composition of the present invention (the active energy ray-curable composition may be referred to as a composition, hereinafter) are not particularly limited, so long as they are able to give necessary energy for allowing polymerization reaction of polymerizable components in the composition to proceed. Examples of the active energy rays include electron beams, α rays, β rays, γ rays, and X rays, in addition to ultraviolet rays. When a light source having a particularly high energy is used, polymerization reaction can be allowed to proceed without a polymerization initiator. In the case of irradiation of ultraviolet rays, use of a GaN-based semiconductor ultraviolet light-emitting device is very advantageous from the industrial and environmental points of view, because a mercury-free society is strongly demanded from the viewpoint of environmental protection. An ultraviolet light-emitting diode (UV-LED) and an ultraviolet laser diode (UV-LD) are preferable as an ultraviolet light source, because they have a small size, a long life span, and a high efficiency, and are inexpensive.

The composition of the present invention contains reactive compounds including two or more kinds of multifunctional monomers. One of the two or more kinds of multifunctional monomers is glycerin tri(meth)acrylate. A content of the multifunctional monomers is 90% by mass or greater relative to a total mass of the reactive compounds.

In the present invention, a multifunctional monomer refers to a monomer having three or more reactive groups, and glycerin tri(meth)acrylate refers to glycerin triacrylate or glycerin trimethacrylate that is not modified with, for example, ethylene oxide.

In the present invention, glycerin tri(meth)acrylate is used as one of the multifunctional monomers to be contained in a large amount in the composition, which realizes a low viscosity of the composition, and enables the composition to be jetted from an inkjet head.

However, when glycerin tri(meth)acrylate alone (particularly, glycerin trimethacrylate alone) is used as the multifunctional monomer, a cured product obtained by curing the composition cannot sufficiently be free of stickiness (tackiness) in some cases. Therefore, it is necessary to use other multifunctional monomers having a high viscosity in combination.

In order to increase curability and hardness of a cured product, it is necessary to use multifunctional monomers at a high ratio, and a monofunctional monomer and a bifunctional monomer at low ratios. Hence, the content of the multifunctional monomers is 90% by mass or greater relative to the total mass of the reactive compounds. However, use of the multifunctional monomers alone is preferable. It is preferable that the ratio of the glycerin tri(meth)acrylate be 50% by mass or greater, in terms of the viscosity of a resulting ink.

The hardness of the cured product is typically desirably a pencil hardness of H or greater, although it depends on the application of the cured product.

### <Organic Solvent>

The composition of the present invention may contain an organic solvent, but if possible, it is preferred that the composition be free of an organic solvent. The composition free of an organic solvent, particularly a volatile organic solvent (Volatile Organic Compounds (VOC)-free composition) will further increase the safety of places where the composition is handled, and also can prevent environmental contamination. The “organic solvent” refers to a common, non-reactive organic solvent such as ethers, ketones, xylene, ethyl acetate, cyclohexanone, and toluene, and is distinguished from the reactive monomer. Furthermore, when it is said that the composition is “free of” an organic solvent, it is meant that the composition is substantially free of an organic solvent. It is preferable that the content of an organic solvent in the composition be less than 0.1% by mass.

The composition of the present invention contains a monomer that is copolymerizable with glycerin tri(meth)acrylate. Examples of the monomer includes radically polymerizable or anionically polymerizable compounds. Preferable examples thereof include monofunctional to multifunctional (meth)acrylate derivatives or acrylamide derivatives. Specific examples thereof include, but are not limited to, compounds (A-1) to (A-12) below.

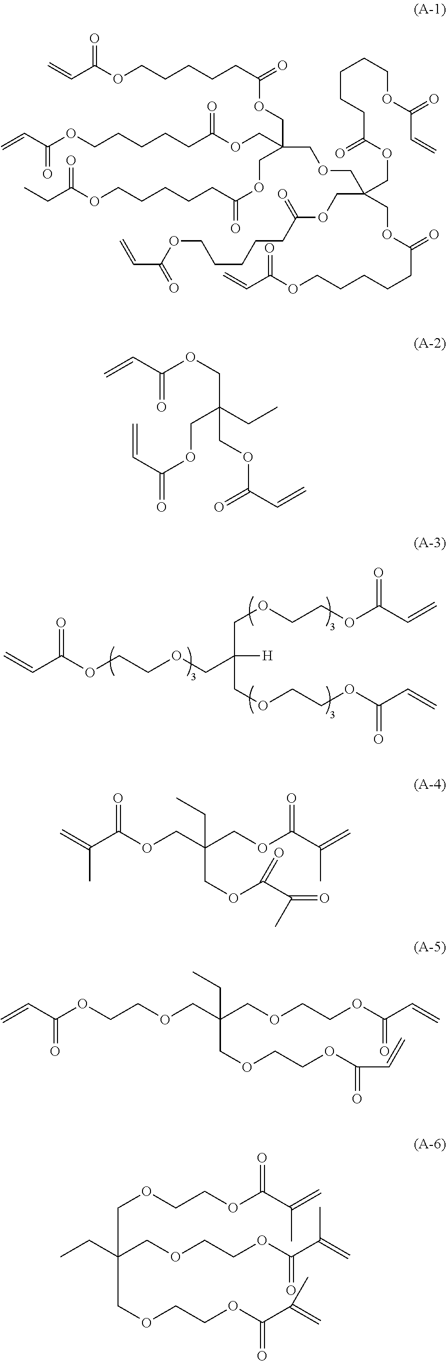

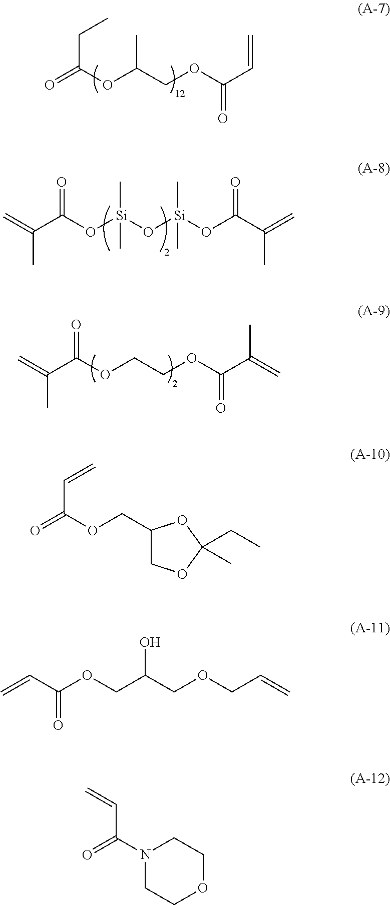

In addition to the monomers described above, a photoinitiator may be added to the composition of the present invention. In order to obtain a sufficient curing speed, it is preferable that the photoinitiator be contained in the composition in an amount of from 5% by mass to 20% by mass relative to the total mass (100% by mass) of the composition. Examples of conventionally known photoradical polymerization initiators include benzophenones, alkylphenones, acylphosphine oxides, oxyphenyl acetate esters, benzoin ethers, oxime esters, and thioxanthones. Specific examples thereof include, but are not limited to, compounds (B-1) to (B-4) below.

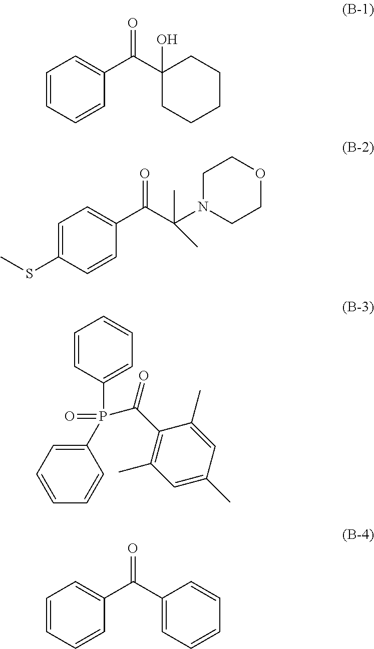

Various known photobase generators may also be used. Examples thereof include oxime esters, quaternary ammonium salts, acyl compounds, and carbamates. Specific examples thereof include, but are not limited to, compounds (C-1) to (C-4) below.

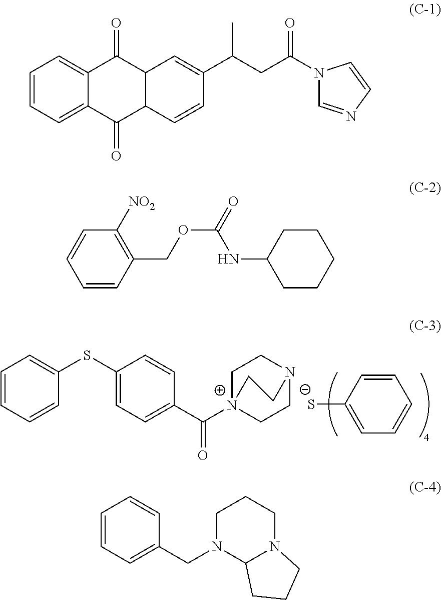

A polymerization accelerator (a sensitizer) may also be used in combination with the photoinitiator. The polymerization accelerator is not particularly limited, and preferable examples thereof include amine compounds such as trimethylamine, methyldimethanolamine, triethanolamine, p-diethylaminoacetophenone, ethyl p-dimethylaminobenzoate, 2-ethylhexyl p-dimethylaminobenzoate, N,N-dimethylbenzylamine, and 4,4′-bis(diethyl amino)benzophenone. A content of the polymerization accelerator in the composition may be set appropriately depending on a polymerization initiator used and a content thereof.

### <Colorant>

The composition of the present invention may contain a colorant. As the colorant, various pigments and dyes may be used that impart black, white, magenta, cyan, yellow, green, orange, and gloss colors such as gold and silver, depending on the intended purpose of the composition and requisite properties thereof. A content of the colorant in the composition is not particularly limited, and may be appropriately determined considering, for example, a desired color density and dispersibility of the colorant in the composition. However, it is preferably from 0.1% by mass to 20% by mass relative to the total mass (100% by mass) of the composition.

The composition of the present invention may be free of a colorant, and be colorless and transparent. In this case, the composition is suitable as, for example, an overcoat layer for protecting an image.

The pigment usable may be an inorganic pigment or an organic pigment. One pigment may be used alone, or two or more pigments may be used in combination.

Examples of the inorganic pigment include: carbon black (C.I. pigment black 7) such as furnace black, lamp black, acetylene black, and channel black; iron oxide; and titanium oxide.

Examples of the organic pigment include: azo pigments such as an insoluble azo pigments, condensed azo pigments, azo lake, and chelate azo pigments; polycyclic pigments such as phthalocyanine pigments, perylene and perinone pigments, anthraquinone pigments, quinacridone pigments, dioxane pigments, thioindigo pigmenst, isoindolinone pigments, and quinophthalone pigments; dye chelates (e.g., basic dye-type chelates and acid dye-type chelates); dye lake (e.g., basic dye-type lake and acid dye-type lake); nitro pigments; nitroso pigments; aniline black; and daylight fluorescent pigments.

The composition may further contain a dispersant in order to better dispersibility of the pigment. The dispersant is not particularly limited, and examples thereof include dispersants commonly used for preparing a pigment dispersion, such as polymer dispersants.

Examples of the dye usable include acid dyes, direct dyes, reactive dyes, and basic dyes. One kind of these may be used alone, or two or more kinds of these may be used in combination.

The composition of the present invention may contain other components, if necessary. The other components are not particularly limited, and examples thereof include surfactants, polymerization inhibitors, leveling agents, defoamers, fluorescent brighteners, permeation enhancers, wetting agents (humectants), fixing agents, viscosity stabilizers, fungicides, antiseptics, antioxidants, ultraviolet ray absorbers, chelating agents, pH adjusters, and thickeners that are conventionally known.

Applications of the composition of the present invention are not particularly limited, and generally, the composition may be used in any fields in which photocurable materials are used. Examples of the applications include inks and adhesives, but details will be described below.

### <Preparation of Active Energy Ray-Curable Composition>

The composition of the present invention can be produced using the various components mentioned above, and methods and conditions for preparing the composition are not particularly limited. For example, the composition can be prepared by charging and dispersing, for example, the polymerizable monomers, the pigment, and the dispersant in a disperser such as a ball mill, a kitty mill, a disk mill, a pin mill, or DYNO-MILL to produce a pigment dispersion liquid, and further mixing, for example, the polymerizable monomers, the initiator, the polymerization inhibitor, and the surfactant.

### <Viscosity>

The viscosity of the composition of the present invention is not particularly limited, and may be adjusted appropriately depending on the application and means to be employed. When a jetting unit configured to jet the composition from a nozzle is employed, the viscosity of the composition in a temperature range of from 20° C. to 65° C., desirably the viscosity thereof at 25° C. is preferably from 3 mPa·s to 40 mPa·s, more preferably from 5 mPa·s to 15 mPa·s, and particularly preferably from 6 mPa·s to 12 mPa·s. Furthermore, it is particularly preferable that the composition satisfy the above viscosity range in a state free of the organic solvent. The above viscosity can be measured with a cone-and-plate rotary viscometer VISCOMETER TVE-22L manufactured by Told Sangyo Co., using a cone rotor (1° 34′×R24), at a rotation speed of 50 rpm, with the temperature of hemathermal circulating water appropriately set in a range of from 20° C. to 65° C. VISCOMATE VM-150III can be used for adjusting the temperature of the circulating water.

### <Applications>

Applications of the composition of the present invention are not particularly limited, and generally, the composition may be used in any fields in which active energy ray-curable materials are used. Applications of the composition may be selected appropriately depending on the intended purpose. Examples of the applications include resins for molding, paints, adhesives, insulating materials, release agents, coating materials, sealing materials, various resists, and various optical materials.

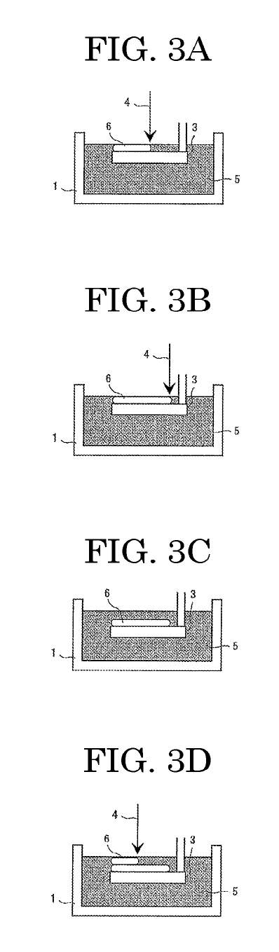

Furthermore, the composition of the present invention may be used not only as an ink to form a two-dimensional character or image, or a design coating over various base materials, but also as a three-dimensional object forming material for forming a three-dimensional, stereoscopic image (a stereoscopic object). This three-dimensional object forming material may also be used as a binder for powder particles used in a powder layer stacking method of forming a three-dimensional object by repeating curing and stacking of powder layers, and as a three-dimensional object constituent material (a model material) and a supporting member (a support member) used in an additive fabrication method (a stereolithography method) illustrated in FIG. 2 and FIGS. 3A to 3D. An image forming method using the image forming apparatus illustrated in FIG. 2 is a method of forming a three-dimensional object by sequentially stacking cured products each obtained by jetting the composition of the present invention to a predetermined region and curing the composition by irradiation of active energy rays (details of which will be described below). FIGS. 3A to 3D are each a schematic view of an example of the image forming apparatus of the present invention, and an image forming method using this image forming apparatus is a method of forming a three-dimensional object by sequentially stacking cured layers 6 each formed over a movable stage 3 to have a predetermined shape by irradiation of active energy rays 4 to a storing pool (a storing section) 1 in which the composition 5 of the present invention is stored.

A three-dimensional object forming apparatus configured to form a three-dimensional object with the composition of the present invention is not particularly limited, and may be a known three-dimensional object forming apparatus. Examples thereof include a three-dimensional object forming apparatus including storing, supplying, and jetting units for the composition and an active energy ray irradiating unit.

The scope of the present invention includes a cured product obtained by curing the composition of the present invention, and a shaped product obtained by processing a structure that is obtained by forming the cured product over a base material. The shaped product is a product obtained by applying shaping such as heat drawing and punching to a cured product or structure formed as, for example, a sheet or film. The shaped product is suitably used for applications in which a product surface needs to be shaped after decorated, such as panels of meters and operation units of automobiles, OA apparatus, electric or electronic appliances, and cameras.

The base material is not particularly limited, and may be selected depending on the intended purpose. Examples thereof include paper, yarns, fibers, cloths, leather, metals, plastics, glass, wood, ceramics, and composite materials thereof. A plastic base material is preferable in terms of processability.

### <Composition Storing Container>

A composition storing container of the present invention refers to a container that is in a state of storing the composition of the present invention. The composition storing container is suitable when the composition is used for the applications as described above. For example, when the composition of the present invention is used as an ink, the container storing the ink can be used as an ink cartridge or an ink bottle. Hence, it is unnecessary to directly touch the ink in such works as ink transportation and ink replacement, and hands and fingers, and clothes can be prevented from contamination. Furthermore, inclusion of foreign matters such as dust in the ink can be prevented. The shape, size, material, and so on of the container itself are not particularly limited, so long as they are suitable for the application, and the method of use. However, it is preferred that the material be a light-blocking material that does not allow light transmission, or that the container be coated with, for example, a light-blocking sheet.

### <Image Forming Method and Image Forming Apparatus>

An image forming method of the present invention includes an irradiating step of irradiating the composition of the present invention with active energy rays in order to cure the composition. An image forming apparatus of the present invention includes an irradiating unit configured to emit active energy rays, and a storing section configured to store the composition of the present invention. The container described above may be housed in the storing section. The method and apparatus may further include a jetting step and a jetting unit to jet the composition of the present invention. A jetting method is not particularly limited, and examples thereof include a continuous jetting method and an on-demand method. Examples of the on-demand method include a piezo method, a thermal method, and an electrostatic method.

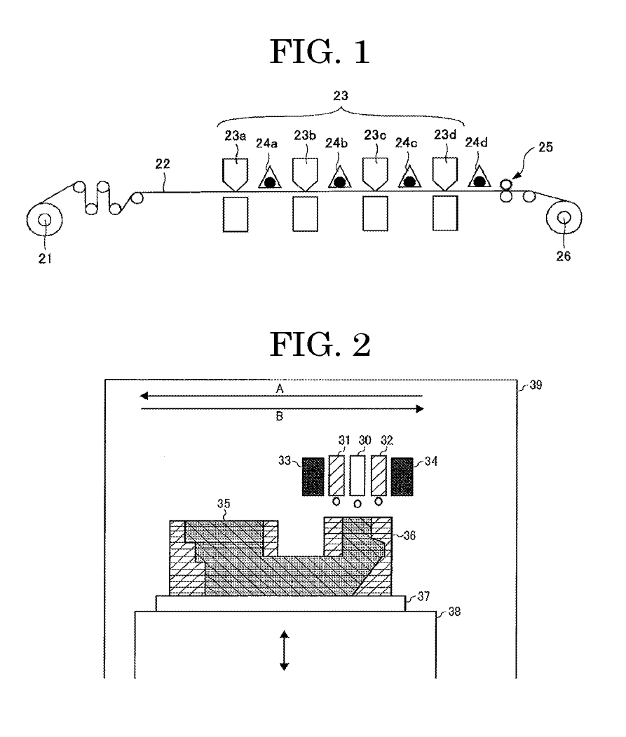

FIG. 1 illustrates an example of an image forming apparatus including an inkjet jetting unit. Printing units 23a, 23b, 23c, and 23d including ink cartridges and jetting heads for active energy ray-curable inks of yellow, magenta, cyan, and black jet the inks onto a recording medium 22 fed from a feeding roller 21. Thereafter, light sources 24a, 24b, 24c, and 24d configured to cure the inks emit active energy rays to the inks, to thereby cure the inks to form a color image. Thereafter, the recording medium 22 is conveyed to a processing unit 25 and a printed matter take-up roller 26. The printing units 23a, 23b, 23c, and 23d may be provided with a heating mechanism so that the inks may be liquefied in the ink jetting portion. Furthermore, if necessary, the image forming apparatus may be provided with a mechanism configured to cool the recording medium to room temperature by a contact or contactless method. The inkjet recording method may be any of a serial method of jetting the inks onto a recording medium by moving the heads relative to the recording medium that is moved intermittently according to the width of the jetting heads, and a line method of moving a recording medium continuously and jetting the inks onto the recording medium from the heads maintained at the constant positions.

The recording medium 22 is not particularly limited, and examples thereof include paper, films, metals, and composite materials thereof. The recording medium 22 may be a sheet. The image forming apparatus may be a one-side printing type or a both-side printing type.

Furthermore, it is also possible to emit a weak active energy ray or omit an active energy ray from the light sources 24a, 2b, and 24c to print multiple colors and thereafter emit an active energy ray from the light source 24d. This enables energy saving and cost saving.

Examples of a recorded matter recorded with the ink of the present invention include not only a printed matter over a smooth surface such as an ordinary paper sheet or resin film, but also a printed matter over a print surface having irregularities and a printed matter over a print surface made of various materials such as metals and ceramics. It is also possible to form an image that is partially stereoscopic (i.e., an image formed of two-dimensional and three-dimensional portions) and a three-dimensional object by stacking two-dimensional images.

FIG. 2 is a schematic view of an example of another image forming apparatus of the present invention (i.e., a three-dimensional, stereoscopic image forming apparatus). Using a head unit in which inkjet heads are arranged (the head unit being movable in the directions A and B), the image forming apparatus 39 is configured to jet a first composition of the present invention from a jetting head unit 30 for an object, and a second composition of the present invention compositionally different from the first composition of the present invention from jetting head units 31 and 32 for a support, cure these compositions with adjacent ultraviolet ray irradiating units 33 and 34, and stack layers of these compositions. More specifically, for example, the second composition of the present invention is jetted from the jetting head units 31 and 32 for a support onto an object supporting substrate 37, and irradiated with active energy rays to be solidified, to thereby form a first support layer having a pooling portion, and thereafter, the first composition of the present invention is jetted from the jetting head unit 30 for an object into the pooling portion, and irradiated with active energy rays to be solidified, to thereby form a first object layer. This step is repeated a plurality of times by lifting down a stage 38, which is movable upward and downward, according to how many layers are to be stacked, to stack support layers and object layers, to thereby produce a three-dimensional object 35. Thereafter, if necessary, a support layer stack 36 in which the support layers are stacked is removed. In FIG. 2, there is only one jetting head unit 30 for an object. However, there may be two or more of the jetting head unit 30 for an object.

### EXAMPLES

The present invention will next be described in detail by way of Examples and Comparative Examples. The present invention should not be construed as being limited to the Examples.

### Examples 1 to 11 and Comparative Examples 1 to 4

Materials presented in the respective fields of Examples and Comparative Examples of Table 1 were mixed and stirred, to thereby prepare active energy ray-curable inkjet inks. Values in the material fields are in the unit of “% by mass”.

Details of the materials denoted by abbreviations in Table 1 are as follows. A-1 to A-12, B-1 to B-2, and C-1 are the compounds (A-1) to (A-12), the compounds (B-1) to (B-2), and the compound (C-1) presented in the foregoing section. PGMEA is an organic solvent.
G-TMA: glycerin trimethacrylate
G-TA: glycerin triacrylate
PGMEA: propylene glycol-1-monomethyl ether-2-acetate
CB: MICROLITH BLACK C-K manufactured by Ciba Japan Co. (a carbon black pigment)
Blue: MICROLITH BLUE 4G-K manufactured by Ciba Japan Co.
PET: a PET film (E5100 manufactured by Toyobo Co., corona-treated)
PP: a PP film (P2161 manufactured by Toyobo Co., corona-treated)

### [Evaluation]

The viscosity of the inks of Examples and Comparative Examples at 25° C. was measured with a rheometer (MCR302 manufactured by Anton Paar GmbH). The results are presented in Table 1.

Using an inkjet head GEN 4 manufactured by Ricoh Company,

Ltd., each of the inks was subjected to a jetting test, and formed into a coating film over a PET film and a PP film. Pencil hardness and close adhesiveness of the recorded portion, and jettability were evaluated. The results are presented in Table 1.

A photocurable condition was 1,200 mJ/cm² in a metal halide lamp as a light source.

Evaluation by the pencil hardness test was conducted according to JIS K5600-5-4. The ink of Comparative Example 3 was not subjected to the pencil hardness test because the ink of Comparative Example 3 had a high viscosity and could not form a coating film.

Close adhesiveness was evaluated according to JIS K5400-8.5. Close adhesiveness was evaluated as A when the coating film was not peeled off, and as B when the coating film was peeled off.

Jettability was evaluated as A when the ink could be jetted, and as B when the ink could not be jetted.

TABLE 1

| | | | | | | | | | | | | | | Comp. | Comp. | Comp. | Comp. |
|---|---|---|---|---|---|---|---|---|---|---|---|---|---|---|---|---|---|
| | | | Ex. | Ex. | Ex. | Ex. | Ex. | Ex. | Ex. | Ex. | Ex. | Ex. | Ex. | Ex. | Ex. | Ex. | Ex. |
| | | | 1 | 2 | 3 | 4 | 5 | 6 | 7 | 8 | 9 | 10 | 11 | 1 | 2 | 3 | 4 |
| Monomer | Multi-functional | G-TMA | 70 | 45 | 50 | — | 50 | 60 | 60 | 60 | 60 | 60 | 45 | — | 40 | — | — |
| | | G-TA | — | — | — | 50 | — | — | — | — | — | — | — | 45 | — | — | — |
| | | A-1 | 30 | 55 | 40 | — | — | — | — | — | — | — | 55 | — | — | 50 | — |
| | | A-3 | — | — | — | 40 | 45 | — | — | — | 40 | — | — | 40 | 45 | — | — |
| | | A-4 | — | — | — | — | — | — | — | — | — | 40 | — | — | — | 50 | — |
| | | A-6 | — | — | — | — | — | 30 | 30 | 30 | — | — | — | — | — | — | 90 |
| | Bi-functional | A-7 | — | — | — | — | 5 | — | — | — | — | — | — | — | 15 | — | — |
| | | A-9 | — | — | — | — | — | 10 | 10 | 10 | — | — | — | — | — | — | 10 |
| | Mono-functional | A-10 | — | — | — | 10 | — | — | — | — | — | — | — | 15 | — | — | — |
| | | A-12 | — | — | 10 | — | — | — | — | — | — | — | — | — | — | — | — |

| | | | | | | | | | | | | | | | | |
|---|---|---|---|---|---|---|---|---|---|---|---|---|---|---|---|---|
| Photoinitiator | B-1 | 10 | — | 10 | — | — | 10 | 10 | 10 | 10 | 10 | — | — | — | 15 | 20 |
| | B-2 | — | 5 | — | 5 | 10 | — | — | — | — | — | 5 | 5 | 10 | — | — |
| | C-1 | — | — | — | 5 | — | — | — | — | — | — | — | 5 | — | — | — |
| Organic solvent | PGMEA | — | 10 | — | — | — | — | — | — | — | — | — | — | — | — | — |
| Colorant | CB | — | — | — | — | — | — | 3 | — | — | — | — | — | — | — | — |
| | Blue | — | — | — | — | — | — | — | 5 | — | — | — | — | — | — | — |

| | | | | | | | | | | | | | | | |
|---|---|---|---|---|---|---|---|---|---|---|---|---|---|---|---|
| 25° C. viscosity [mPa · s] | 31 | 50 | 52 | 20 | 22 | 9 | 15 | 20 | 18 | 13 | 70 | 25 | 20 | 180 | 60 |
| Pencil hardness PET | 5H | H | 2H | H | H | 2H | H | 2H | H | 2H | H | HB | HB | — | H |
| Pencil hardness PP | 5H | H | 3H | H | 2H | H | H | H | H | 2H | 2H | B | HB | — | H |
| Close adhesiveness PET | A | A | A | A | A | A | A | A | A | A | A | A | A | — | B |
| Close adhesiveness PP | A | A | A | A | A | A | A | A | A | A | A | A | A | — | B |
| Jettability | A | A | A | A | A | A | A | A | A | A | A | A | A | B | A |

From the results of Table 1, it can be seen that the inks of Examples had low viscosities and enabled inkjet recording that provided cured products having excellent hardness and close adhesiveness.

As compared with this, it can be seen that the hardness of the cured product could not be sufficiently high when the amount of the monofunctional or bifunctional monomer was high, as in Comparative Examples 1 and 2.

Furthermore, it can be seen that the viscosity of the ink was high unless glycerin tri(meth)acrylate was used as a multifunctional monomer, as in Comparative Example 3.

Moreover, it can be seen that even though the kinds of the multifunctional monomers used were changed in order to suppress the viscosity of the ink, close adhesiveness with PET and PP was not good unless glycerin tri(meth)acrylate was used, as in Comparative Example 4.

This application claims priority to Japanese application No. 2014-188624, filed on Sep. 17, 2014 and incorporated herein by reference, and Japanese application No. 2015-113058, filed on Jun. 3, 2015 and incorporated herein by reference.

What is claimed is:

1. An active energy ray-curable composition, comprising:
reactive compounds including two or more kinds of multifunctional monomers,
wherein one of the two or more kinds of multifunctional monomers is glycerin tri(meth)acrylate, and
wherein a content of the multifunctional monomers is 90% by mass or greater relative to a total mass of the reactive compounds.

2. The active energy ray-curable composition according to claim 1,
wherein a content of the glycerin tri (meth)acrylate is 50% by mass or greater relative to the total mass of the reactive compounds.

3. The active energy ray-curable composition according to claim 1,
wherein the active energy ray-curable composition is free of an organic solvent.

4. The active energy ray-curable composition according to claim 1,
wherein the reactive compounds consist of bifunctional or higher monomers.

5. The active energy ray-curable composition according to claim 1,
wherein the reactive compounds consist of trifunctional or higher monomers.

6. The active energy ray-curable composition according to claim 1,
wherein the active energy ray-curable composition is free of an organic solvent, and
wherein the active energy ray-curable composition has a viscosity of from 3 mPa·s to 40 mPa·s at 25° C.

7. The active energy ray-curable composition according to claim 1,
wherein the active energy ray-curable composition is used for a three-dimensional object forming material.

8. An active energy ray-curable ink, comprising:
reactive compounds including two or more kinds of multifunctional monomers,
wherein one of the two or more kinds of multifunctional monomers is glycerin tri(meth)acrylate, and
wherein a content of the multifunctional monomers is 90% by mass or greater relative to a total mass of the reactive compounds.

9. The active energy ray-curable ink according to claim 8,
wherein the active energy ray-curable ink is used for ink jetting.

10. A composition storing container, comprising:
a container; and
the active energy ray-curable composition according to claim 1 stored in the container.

11. A two-dimensional or three-dimensional image forming apparatus, comprising:
a storing section storing the active energy ray-curable composition according to claim 1; and
an irradiating unit configured to emit active energy rays.

12. A two-dimensional or three-dimensional image forming method, comprising:
irradiating the active energy ray-curable composition according to claim 1 with active energy rays.

13. A cured product obtained by curing the active energy ray-curable composition according to claim 1.

14. A shaped product obtained by processing a structure, the structure including a base material and the cured product according to claim 13 formed over the base material.
